(19) United States
(12) Patent Application Publication
(10) Pub. No.: US 2025/0329098 A1
(43) Pub. Date: Oct. 23, 2025

(54) USER INTERFACE FOR INTERACTING WITH HUMAN USERS

(71) Applicant: Wells Fargo Bank, N.A., San Francisco, CA (US)

(72) Inventors: David P. Bendert, Charlotte, NC (US); Jason Franklin Frye, Monroe, NC (US); Mary Katherine Henley Hoskins, Charlotte, NC (US); Scott D. Hutula, Concord, NC (US); Steven A. Jolley, Chester, SC (US); Dharmendra V. Makwana, Matthews, NC (US); Benjamin Charles Norris, Rock Hill, SC (US); Ravi Kumar Sarvepalli, Matthews, NC (US); Matthew O. Spain, Charlotte, NC (US)

(21) Appl. No.: 18/642,148

(22) Filed: Apr. 22, 2024

(51) Int. Cl. G06T 15/00

(52) U.S. Cl. CPC G06T 15/005

(57) ABSTRACT

Various examples are directed to systems and methods for serving a virtual reality user interface to a user. A computing system may receive, from a user device, an indication that a user avatar for the user is to encounter a third-party avatar associated with a third party in a virtual environment. The computing system may access trust data describing a level of trust between the user and the third party and determine a first visual indicator based at least in part on the level of trust between the user and the third party. The computing system may generate a rendering of the third-party avatar comprising the first visual indicator and serve the rendering of the third-party avatar to the user device for display by the user device to the user.

### BACKGROUND

Virtual reality (VR), augmented reality (AR), and extended reality (ER) technology provide users with virtual environments where users can interact with other users, purchase goods and services from merchants, and engage in gaming. In a virtual environment, users, merchants, and other parties may be represented by avatars. An avatar is a virtual representation of a user that is visible to other users participating in the virtual environment.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of an environment including a VR host computing system.

FIG. 2 is a diagram showing another example of the environment of FIG. 1 including additional details.

FIG. 3 is a flowchart showing one example of a process flow that may be executed in the environment of FIG. 1 to provide a VR user interface to a user.

FIG. 4 is a flowchart showing one example of a process flow that may be executed in the environment of FIG. 1 to provide a VR user interface to a user and to provide user data to the third party.

FIG. 5 is a flowchart showing one example of a process flow that may be executed in the environment of FIG. 1, for example, by the VR host computing system to determine a level of trust between a user and a third party.

FIG. 6 shows an example VR user interface illustrated with three avatars.

FIG. 7 shows an example VR user interface illustrated with three avatars demonstrating an additional example for rendering third-party avatars to include visual indicators of trust.

FIG. 8 shows an example VR user interface illustrated with three avatars demonstrating an additional example for rendering third-party avatars to include visual indicators of trust.

FIG. 9 shows an example VR user interface illustrated with three avatars showing an example way of providing user data to third parties.

FIG. 10 shows an example VR user interface illustrated with three avatars demonstrating an additional example for rendering third-party avatars to include visual indicators of trust.

FIG. 11 shows an example VR user interface illustrated with three avatars.

FIG. 12 is a flowchart showing one example of a process flow that may be executed in the environment of FIG. 1 to generate a rendering of an avatar.

FIG. 13 is a block diagram showing one example of a software architecture for a computing device.

FIG. 14 is a block diagram illustrating a computing device hardware architecture, within which a set or sequence of instructions can be executed to cause a machine to perform examples of any one of the methodologies discussed herein.

### DETAILED DESCRIPTION

Virtual environments in which users participate in using avatars may be used for various different types of commercial and social interactions that have historically been performed in person. For example, a user may visit a site in the virtual environment associated with a merchant. When the user visits the merchant's site, the user's avatar may be visible to one or more third parties associated with the merchant and one or more third-party avatars associated with the merchant may be visible to the user. The user may interact with one or more of the third-party avatars to purchase goods and/or services.

In some examples, a user may receive professional services in the virtual environment such as financial services, legal services, and/or the like. The user may visit a site in the virtual environment that is associated with a provider of professional services. When the user visits the professional service provider's site, the user's avatar may be visible to one or more third parties associated with the professional service provider and one or more third-party avatars associated with the professional service provider may be visible to the user. The one or more third-party avatars may interact with the user through the user's avatar to provide professional services. Also, a user may interact with other avatars associated with other users in the virtual environment. Interactions between users and their avatars may be of a social or professional nature.

When interactions such as, for example, merchant purchases, the providing of professional services, and other social and professional interactions occur in-person, a user or other individual may have a level of confidence about the identity of third parties and the security of any transactions with third parties. For example, when a user hands a tangible payment element, such as a credit card, to a clerk or puts the tangible payment element into a tangible machine at a merchant location, the user may have a level of confidence about the identity of the party to whom the user is providing his or her payment element information. Also, when the user travels to the office of a professional service provider to receive a financial service, the user may be comfortable giving sensitive personal data to the financial service provider. Similarly, if the user transacts with a third party via telephone, the user may have a level of confidence as to the identity of the third party based on the phone number that the third party is using.

The level of confidence that a user may have in the identity of third parties and the security of transactions with third parties may be compromised in a virtual environment. For example, in a virtual environment, parties such as professional service advisors, merchants, and/or the like may provide sites on a platform provided by a VR host. Users may interact with users and third parties by visiting the sites through the VR host. Accordingly, users may not be using a telephone number they know to be associated with a particular counterparty or visiting a physical location that they know to be associated with the counterparty. Further, the user may not have an adequate way of knowing if an avatar encountered in the virtual environment is as represented.

Also, a virtual environment may lack clear ways to provide data, including potentially sensitive data, to other users. For example, when visiting a bricks-and-mortar professional services office, an individual may bring papers or other records to provide to the professional service provider. Also, the professional service provider may provide papers or other records to the individual in a secure way. In a virtual environment, however, sharing data while also maintaining the privacy of the data from other users and potentially malicious actors may be more difficult.

Various examples address these and other challenges in a virtual reality environment by rendering avatars based on trust data. For example, a VR host computing system may receive an indication that a user avatar for a user is to encounter a third-party avatar. The VR host computing system may access trust data that describes a level of trust between the user and the third party. The level of trust may be determined in any suitable manner, for example, as described herein. The VR host computing system may generate the third-party avatar comprising a visual indicator that is based on the level of trust. In this way, when the user reviews the third-party avatar, the user may see the indicator and receive a sense of how trustworthy the avatar may be.

Also, various examples may address these and other challenges by providing for the security of user data. User data may include, for example, payment element data describing one or more payment elements of the user and personal data describing the user. The VR host computing system may utilize the trust data to determine a portion of user data that is shareable with the third party. The VR host computing system may send the portion of the user data to the third party, for example, via a third-party computing device. In some examples, the VR host computing system may send the portion of the user data in response to a prompt from the user. In this way, the user may securely manage data in a virtual environment.

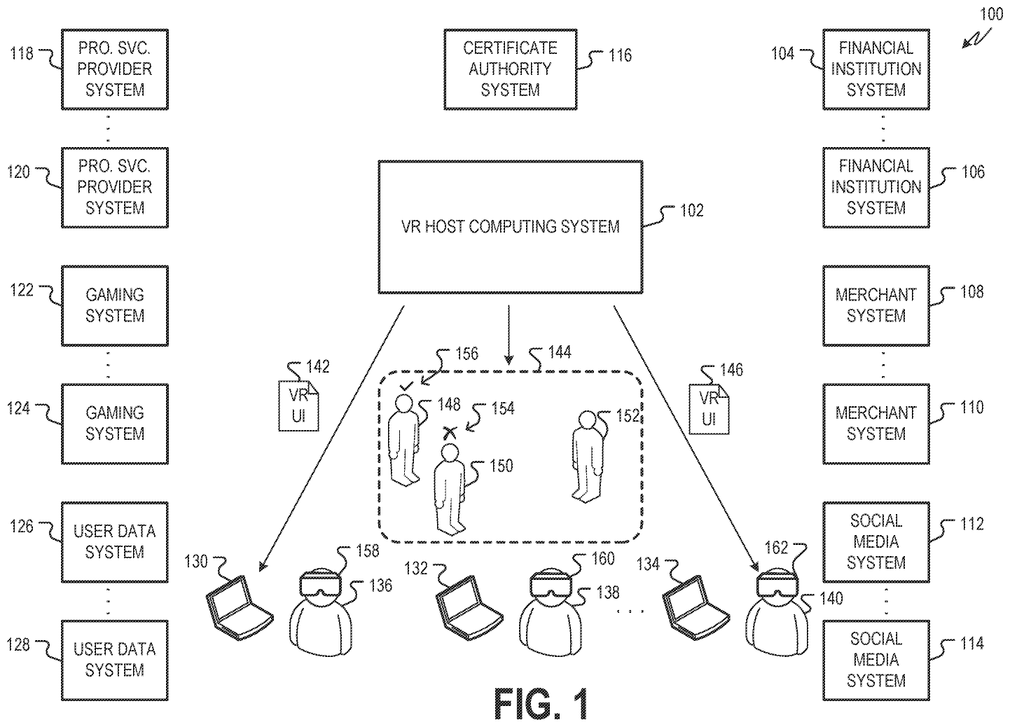

FIG. 1 is a diagram showing one example of an environment 100 including a VR host computing system 102. The VR host computing system 102 provides VR user interfaces 142, 144, 146 to users 136, 138, 140. The VR user interfaces 142, 144, 146 may be served to the users 136, 138, 140 via user computing devices 130, 132, 134 and/or VR appliances 158, 160, 162. The VR user interfaces 142, 144, 146 provide access to a VR environment that may include various different sites. For example, various other systems may be in communication with the VR host computing system 102 in order to provide sites in the VR environment.

Financial institution systems 104, 106 may be associated with one or more respective financial institutions. The financial institution systems 104, 106 may provide sites in the virtual environment that can be visited by users 136, 138, 140. For example, sites provided by financial institution systems 104, 106 may facilitate the providing of financial services to users 136, 138, 140.

Merchant systems 108, 110 may be associated with one or more respective merchants. Merchant systems 108, 110 may provide sites in the virtual environment that facilitate the purchase of goods and/or services by the users 136, 138, 140.

Social media systems 112, 114 may be associated with one or more social media platform providers. The social media systems 112, 114 may provide sites in the virtual environment that facilitate participation by the users 136, 138, 140 in respective social media platforms.

Professional service provider systems 118, 120 may be associated with professional service providers such as, for example, financial advisers, tax preparers, attorneys, and/or the like. Professional service provider systems 118, 120 may provide sites in the virtual environment that can be visited by the various users 136, 138, 140 to facilitate the providing of professional services to the users 136, 138, 140.

Gaming systems 122, 124 may be associated with game providers. The gaming systems 122, 124 may provide sites in the virtual environment that may be visited by the users 136, 138, 140. Users 136, 138, 140 may visit gaming sites provided by the gaming systems 122, 124 to participate in various different games such as, for example, video games, gaming, and/or the like.

FIG. 1 also shows user data systems 126, 128 and a certificate authority system 116. User data systems 126, 128 may store user data associated with one or more of the users 136, 138, 140. In some examples, user data systems 126, 128 may comprise a cloud storage or other data persistence where users 136, 138, 140 may store user data in a way that is accessible to the VR host computing system 102. In some examples, user data for users 136, 138, 140 may also be stored at other various systems. For example, user data of a user 136, 138, 140 describing payment elements may be stored at one or more financial institution system 104, 106. Also, for example, personal data of a user may be stored at a professional service provider system 118, 120 of a provider associated with the user 136, 138, 140.

The certificate authority system 116 may be utilized by various users 136, 138, 140 and/or parties associated with various systems 104, 106, 108, 110, 112, 114, 118, 120, 122, 124, 126, 128. For example, the certificate authority system 116 may provide users 136, 138, 140 and third parties with digital certificate data verifying the identity of the users 136, 138, 140 and third parties.

The VR host computing system 102 may serve the VR user interfaces 142, 144, 146 to the users 136, 138, 140 via the respective user computing devices 130, 132, 134 and/or VR appliances 158, 160, 162. The user computing devices 130, 132, 134 may be any suitable computing device or devices such as, for example, smart phones, tablet computers, laptop computers, smart watches, and/or the like. User computing devices 130, 132, 134 comprise input/output (I/O) devices for providing the VR user interfaces 142, 144, 146 to the users 136, 138, 140. For example, user computing devices 130, 132, 134 comprise a display for showing all or part of the VR user interfaces 142, 144, 146 to users 136, 138, 140.

In some examples, all or part of the VR user interfaces 142, 144, 146 may be provided via VR appliances 158, 160, 162. VR appliances 158, 160, 162 may be configured to be worn over the user's eyes. The VR appliances 158, 160, 162 may comprise displays positioned to be viewed by the users 136, 138, 140. In some examples, VR appliances 158, 160, 162 may also comprise audio output devices such as speakers, headphones, ear buds, and/or the like. In some examples, a VR appliance 158, 160, 162 may completely block the user's eyes so that images provided by displays of the VR appliance are the only images perceived by the users 136, 138, 140. In other examples, a VR appliance 158, 160, 162 may partially obscure the user's vision and/or may not obscure the user's vision. For example, a rendering of the VR user interface 142, 144, 146 may be superimposed over a user's existing field-of-view, in an arrangement that may be referred to as augmented reality (AR) or extended reality (ER).

In some examples, VR appliances 158, 160, 162 are in direct communication with the VR host computing system 102 and may receive all or part of the VR user interfaces 142, 144, 146 directly from the VR host computing system 102. In other examples, the VR appliances 158, 160, 162 are in communication with respective user computing devices 130, 132, 134. The user computing devices 130, 132, 134 may receive the VR user interfaces 142, 144, 146 from the VR host computing system 102 and provide all or parts of the VR user interfaces 142, 144, 146 to the respective VR appliances 158, 160, 162 for display to the users 136, 138, 140.

In some examples, user computing devices 130, 132, 134 and/or VR appliances 158, 160, 162 execute an application that facilitates the provision of the VR user interfaces 142, 144, 146. In some examples, the application is a web browser that communicates with the VR host computing system 102 to receive and display the VR user interfaces 142, 144, 146. For example, the VR user interfaces 142, 144, 146 may be or include a web page displayed at the user computing device 130, 132, 134 via the web browser.

Serving the VR user interfaces 142, 144, 146 to the users 136, 138, 140 may include serving renderings of various avatars. For example, the VR user interface 144 is illustrated with three avatars 148, 150, 152. In this example, the avatar 152 is a user avatar representing the user 138. The avatars 148, 150 are third-party avatars representing third parties such as other users 136, 140, users associated with the various systems 104, 106, 108, 110, 112, 114, 118, 120, 122, 124, 126, 128, and/or the like. In the example of FIG. 1, third-party avatars 148, 150 are rendered with visual indicators 154, 156 that are based on a level of trust between the respective third parties and the user 138. The visual indicators 154, 156 may be visible to the user 138 with the avatars 148, 150. The form of the visual indicators 154, 156 may indicate the level of trust between the user 138 and the respective third parties. In this example, the visual indicator 154 is an “X” indicating a low level of trust. The visual indicator 156 is a check mark indicating a higher level of trust.

Various other types of visual indicators may be associated with third-party avatars 148, 150 to indicate a level of trust between the user and the respective third parties. In one example visual indicator, a perimeter of the third-party avatar 148, 150 may be modified, for example by blurring or otherwise obscuring the perimeter. This may indicate, for example, a lower level of trust between the user and the third party. In other examples, a color of all or a portion of the respective third-party avatars 148, 150 may be modified. For example, different colors may indicate different levels of trust between the user and the respective third parties.

In some examples the user avatar 152 may also be rendered with one or more visual indicators determined based on the level of trust between the user and one or more third parties. In some examples, the visual indicator is a depiction of a face of the user 138. A visual indicator indicating a face of the user may be used when a level of trust between the user and the third party exceeds a threshold level. Another example of a visual indicator is a blurring or obscuring of the avatar 152. The user's avatar 152 with a trust level-based visual indicator may be served in a blurred manner, obscured in a cloud, and/or otherwise served in a manner that obscures the identity of the user from third parties having a low level of trust with the user.

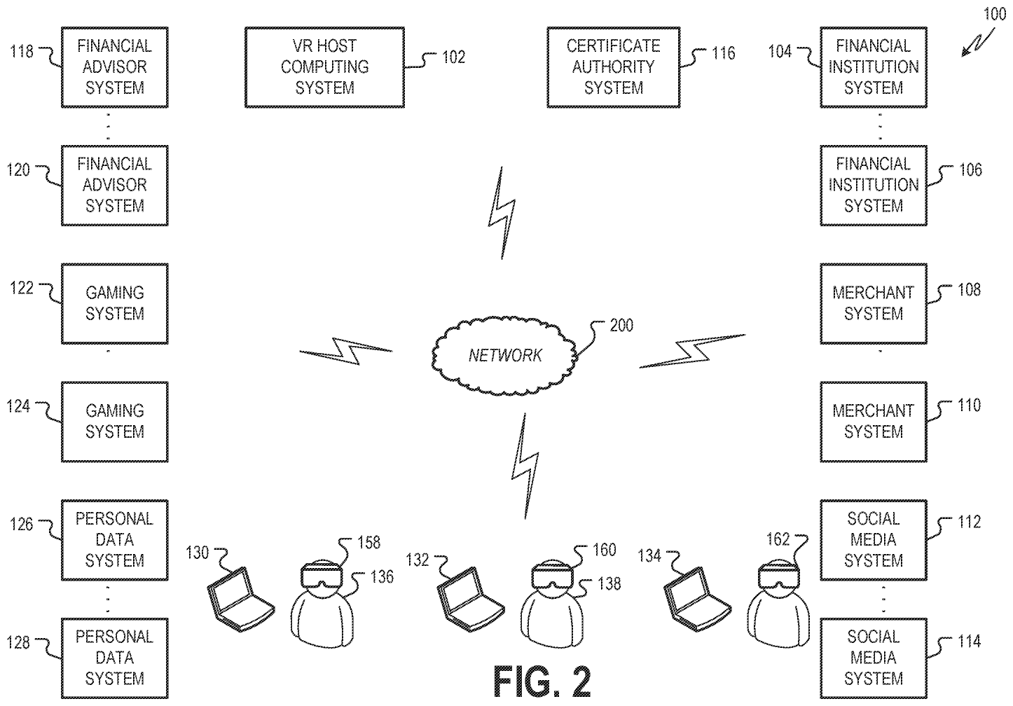

FIG. 2 is a diagram showing another example of the environment 100 including additional details. In the example of FIG. 2, the VR host computing system 102; user computing devices 130, 132, 134; VR appliances 158, 160, 162; certificate authority system 116; and systems 104, 106, 108, 110, 112, 114, 118, 120, 122, 124, 126, 128 are in communication with one another via a network 200. The network 200 may be or comprise any suitable network element operated according to any suitable network protocol. For example, one or more portions of the network 200 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, another type of network, a combination of two or more such networks, and so forth.

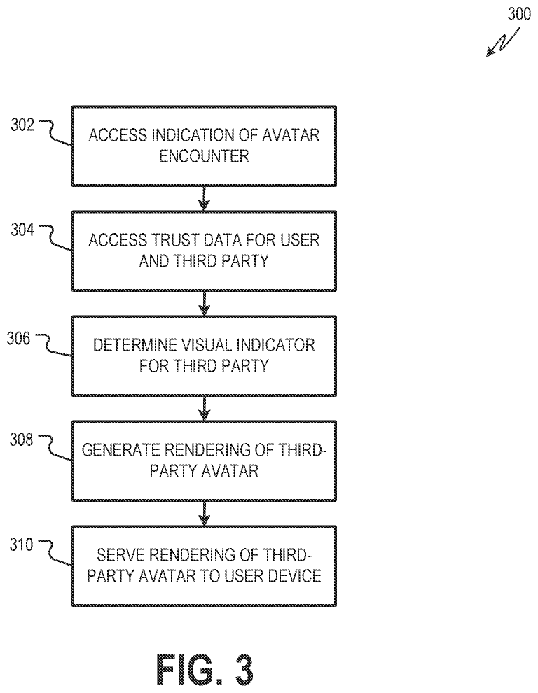

FIG. 3 is a flowchart showing one example of a process flow 300 that may be executed in the environment 100 to provide a VR user interface to a user. At operation 302, the VR host computing system 102 may access an indication of an avatar encounter. An avatar encounter may occur when the user takes an action in the virtual environment that causes the user to view a third-party avatar associated with a third party. For example, the user may provide an instruction to the VR host computing system 102 indicating that the user would like to move through the virtual environment. The VR host computing system 102 may receive similar instructions from third parties, such as other users. An avatar encounter may occur when two parties, including the user, are virtually in proximity in the VR environment such that the third party's avatar is visible to the user and/or the user's avatar is visible to the third party. For example, the VR host computing system 102 may render the other party's avatar and provide the rendering as part of the VR user interface 142, 144, 146.

Upon accessing an indication of an avatar encounter, the VR host computing system 102 may access trust data for the user and the third party associated with the third-party avatar at operation 304. The trust data may indicate a level of trust between the user and the third party. The trust data may be accessed in any suitable manner. In some examples, the VR host computing system 102 may prompt the third party to provide a digital certificate or other data authenticating the third party. For example, the third party may possess a digital certificate signed using a private key of the certificate authority system 116. The third party may provide the digital certificate to the VR host computing system 102. The VR host computing system 102 may decrypt the digital certificate using a public key of the certificate authority system 116 to verify the identity of the third party.

In some examples, accessing the trust data for the user and the third party may comprise accessing records of previous interactions between the user and the third party. For example, if the user and the third party have interacted previously, the quantity and type of interactions may comprise all or part of the trust data. For example, the third party may be a merchant operating a merchant site in the virtual environment via a merchant system 108, 110. If the user has conducted multiple purchases from the merchant, including providing payment element data to the merchant, it may indicate a high level of trust between the user and the merchant.

At operation 306, the VR host computing system 102 may determine a visual indicator for the third party. The visual indicator may be an addition or modification to a third-party avatar associated with the third party. The visual indicator may indicate the level of trust between the user and the third party.

Various different types of visual indicators may be used. In some examples, the visual indicator comprises a badge or token that is to be positioned on or near the third-party avatar. In some examples, the visual indicator is or comprises a blurring of a perimeter of the third-party avatar such that the third-party avatar appears blurry to the user. In some examples, the visual indicator is or comprises a color that is added to the third-party avatar. Various other visual indicators may also be used. In some examples, the visual indicator or indicators used may be selected by the user. For example, the user may select from a set of visual indicator types, with each set of visual indicator type including different visual indicators corresponding to different levels of trust between the user and the third party.

At operation 308, the VR host computing system 102 generates a rendering of the third-party avatar. This may include, for example, accessing a template for the third-party avatar and incorporating the visual indicator into the template. At operation 310, the VR host computing system 102 may serve the rendering of the third-party avatar to a user device associated with the user. The user device may be a user computing device 130, 132, 134 and/or a VR appliance 158, 160, 162. The user computing device 130, 132, 134 and/or VR appliance 158, 160, 162 may display the rendering of the third-party avatar to the user.

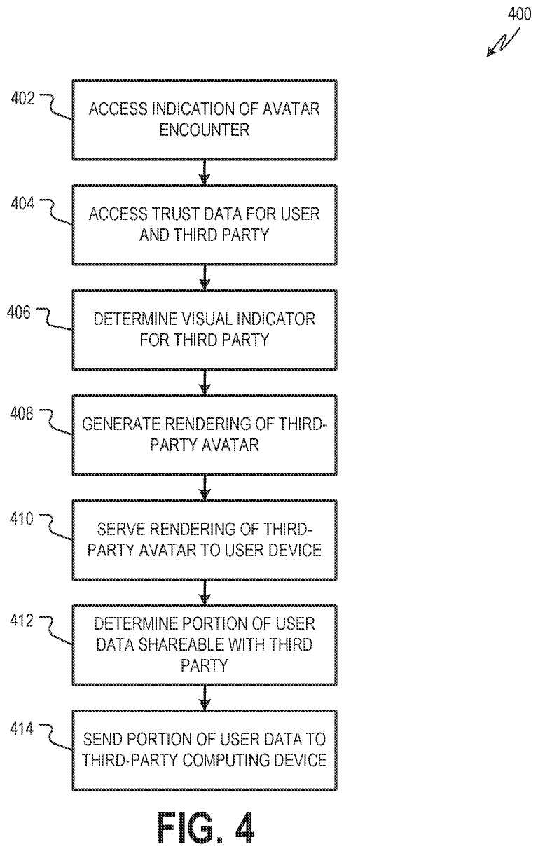

FIG. 4 is a flowchart showing one example of a process flow 400 that may be executed in the environment 100 to provide a VR user interface to a user and to provide user data to the third party. At operation 402, the VR host computing system 102 may access an indication of an avatar encounter. At operation 404, the VR host computing system 102 may access trust data for the user and the third party associated with the third-party avatar. At operation 406, the VR host computing system 102 may determine a visual indicator for the third party. At operation 408, the VR host computing system 102 generates a rendering of the third-party avatar. At operation 410, the VR host computing system 102 may serve the rendering of the third-party avatar to a user device associated with the user. The user device may be a user computing device 130, 132, 134 and/or a VR appliance 158, 160, 162. The user computing device 130, 132, 134 and/or VR appliance 158, 160, 162 may display the rendering of the third-party avatar to the user.

At operation 412, the VR host computing system 102 determines a portion of user data that is shareable with the third party. The determination may be based at least in part on the trust data. As described herein, user data may include personal data as well as payment element data. Payment element data may describe a payment element associated with a credit, deposit, or other account of the user. For example, a payment element may be used to provide a payment for goods and/or services. For example, the payment element may be or represent a credit card account, a checking account, a savings account, etc.

User data may also include personal data describing the user. Personal data may include, for example, contact information for the user such as, for example, a phone number, an email, and address, and/or the like. Personal data may also include, for example, images of the user including, for example, a depiction of the user's face.

The VR host computing system 102 may determine the user data to be shared based on the trust data. For example, the user may set up different tiers or trenches of user data that are to be provided to third parties having different levels of trust. For example, third parties who are other users that are close friends or family with the user may be provided with a high level of personal data. Also, users who are trusted business partners, such as, professional service providers, financial institutions, merchants, and/or the like may be provided with a determined level of access to the user data.

At operation 414, the VR host computing system 102 may send the portion of the user data shareable with the third party to the third party. In some examples, this may include providing the data directly to a computing device associated with the third party, such as a user computing device 130, 132, 134; a VR appliance 158, 160, 162; and/or to one or more of the various systems 104, 106, 108, 110, 112, 114, 118, 120, 122, 124, 126, 128. Also, in some examples, this may include rendering a version of the VR user interface 142, 144, 146 to include the data.

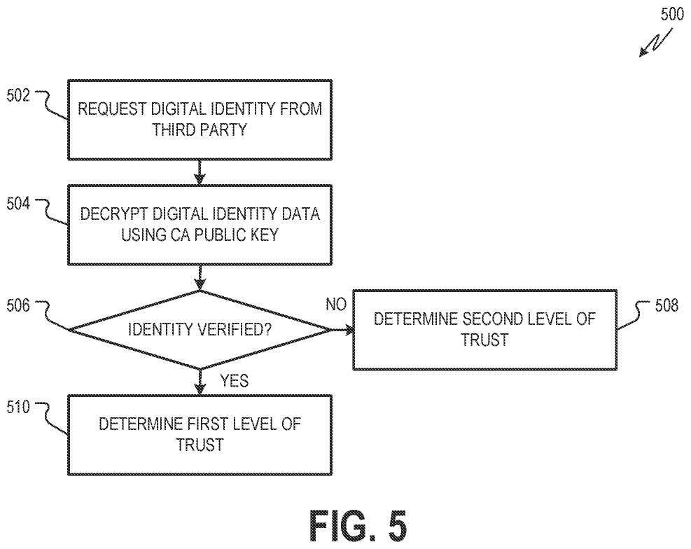

FIG. 5 is a flowchart showing one example of a process flow that may be executed in the environment 100 of FIG. 1, for example, by the VR host computing system 102 to determine a level of trust between a user and a third party. For example, the VR host computing system 102 may execute the process flow 500 when a user avatar encounters a third-party avatar. For example, the process flow 500 may be executed as a part of and/or in conjunction with operation 304 of the process flow 300 and/or operation 404 of the process flow 400.

At operation 502, the VR host computing system 102 may request digital identity data from the third party. When the third party is a user 136, 138, 140, this may include sending the request for digital identity data to the user computing device 130, 132, 134 and/or VR appliance 158, 160, 162 associated with the user. When the third party is or is associated with a system, such as one of the systems 104, 106, 108, 110, 112, 114, 118, 120, 122, 124, 126, 128, requesting the digital identity data may include sending a request to the appropriate system 104, 106, 108, 110, 112, 114, 118, 120, 122, 124, 126, 128.

The digital identity data may include unencrypted identity data describing the identity of the third party such as, for example, a name of the third party, an organization associated with the third party, and/or the like. The digital certificate may also include encrypted data. The encrypted data may have been encrypted using a private key of the certificate authority system 116.

At operation 504, the VR host computing system 102 may decrypt all or part of the encrypted data included with the digital identity data. For example, the VR host computing system 102 may receive a public key of the certificate authority system 116. In some examples, the VR host computing system 102 may query the certificate authority system 116 to receive the public key.

At operation 502, the VR host computing system 102 may determine if the decrypted identity data matches the unencrypted identity data. If the decrypted identity data matches the unencrypted identity data, it may indicate that the certificate authority system has verified the identity of the third party and encrypted the unencrypted identity data using the private key of the certificate authority. That is, if the decrypted identity data matches the unencrypted identity data, it may indicate that the actual identity of the third-party matches the identity provided by the third party.

If, at operation 506, the identity of the third party is verified, then the VR host computing system 102 may assign the third party a first level of trust at operation 510. If the identity of the third party is not verified, then the VR host computing system 102 may assign the third party a second level of trust at operation 508. The second level of trust may be lower than the first level of trust. In some examples, if the third party's identity is not verified, the VR host system 102 may prevent the third party from interacting with the user.

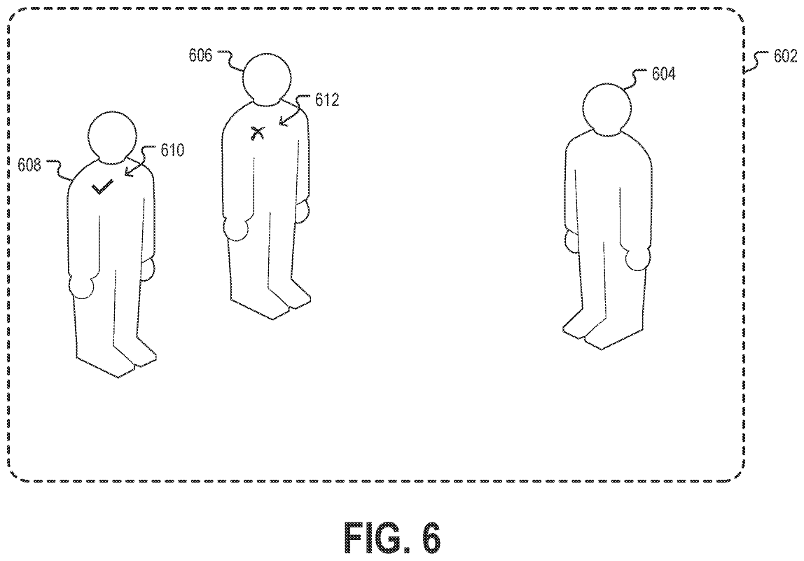

FIG. 6 shows an example VR user interface 602 illustrated with three avatars 604, 606, 608. In this example, the avatar 604 is associated with a user and the avatars 606, 608 are associated with third parties. In some examples, the avatars 604, 606, 608 may be rendered by the VR host computing system 102 with the renderings provided to a user computing device 130, 132, 134 and/or VR appliance 158, 160, 162 associated with the user. In the example of FIG. 6, third-party avatars are rendered with visual indicators 610, 612 describing a level of trust between the user, represented by avatar 604, and the respective third parties represented by avatars 606, 608.

The visual indicators 610, 612, in this example, are items depicted on the respective avatars 606, 608. In the example of FIG. 6, the third party represented by third-party avatar 606 may have a low level of trust relative to the user. Accordingly, the visual indicator 612 is an item “X” indicating a low level of trust. On the other hand, the third party represented by third-party avatar 608 may have a higher level of trust relative to the user. Accordingly, the visual indicator 610 is a checkmark item indicating a high level of trust. In this way, the user may know a level of trust associated with the third parties represented by the respective avatars 606, 608. In the example of FIG. 6, the visual indicators 610, 612 are items that are positioned on or adjacent to the respective avatars 606, 608.

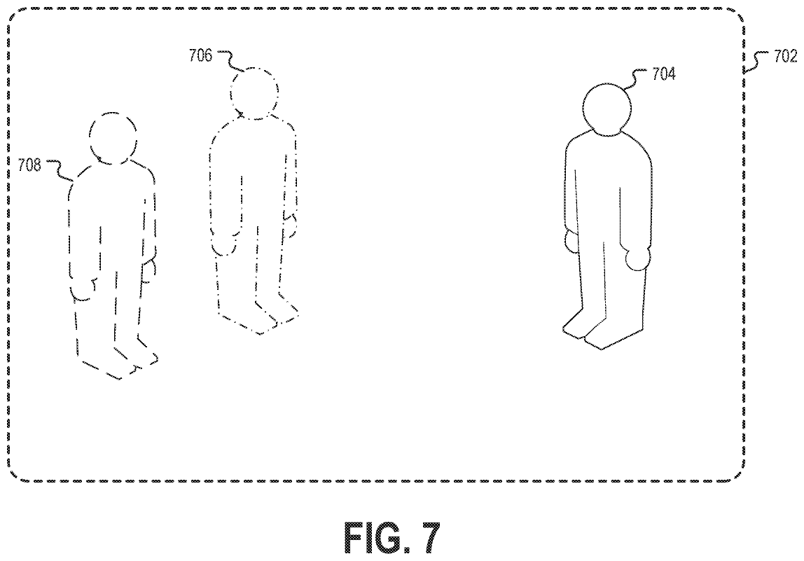

FIG. 7 shows an example VR user interface 702 illustrated with three avatars 704, 706, 708 demonstrating an additional example for rendering third-party avatars to include visual indicators of trust. In some examples, the avatars 704, 706, 708 may be rendered by the VR host computing system 102 with the renderings provided to a user computing device 130, 132, 134 and/or VR appliance 158, 160, 162 associated with the user. In the example of FIG. 7, third-party avatars are rendered with visual indicators describing a level of trust between the user, represented by avatar 704, and the respective third parties represented by avatars 706, 708. In the example of FIG. 7, visual indicators are provided by modifying the perimeter of the respective avatars 706, 708. For example, the perimeter of the respective avatars 706, 708 may be blurred or smudged to indicate a lower level of trust relative to the user. In some examples, the perimeter of the respective avatars 706, 708 may have a color modified. For example, a color indicating the level of trust between the user and the respective third party may be added to all or part of the perimeter of the respective avatars 706, 708. Different types or levels of perimeter modifications may indicate different levels of trust between the respective third parties and the user. In the example of FIG. 7, the third party associated with the avatar 706 has a first level of trust with the user and a first type of perimeter modification. The third party associated with avatar 708 has a second level of trust with the user and a second type of perimeter modification. In some examples, blurring or smudging the perimeter of an avatar may indicate a low level of trust.

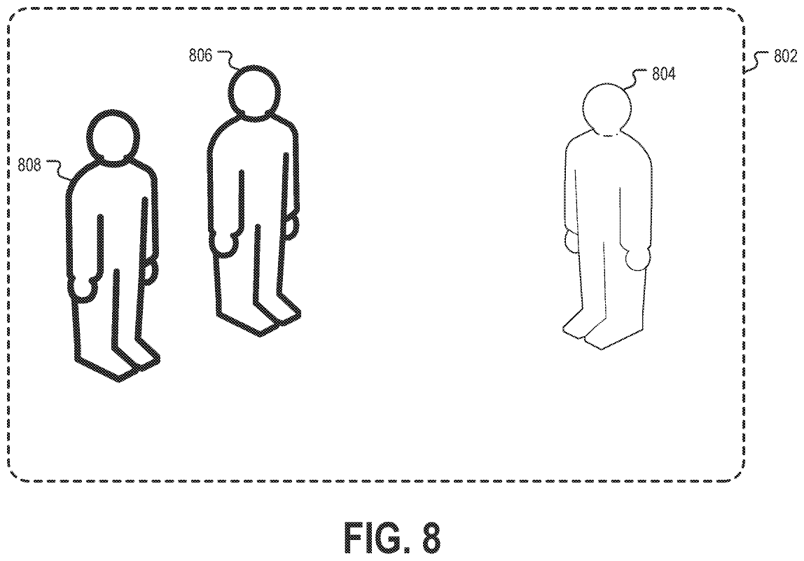

FIG. 8 shows an example VR user interface 802 illustrated with three avatars 804, 806, 808 demonstrating an additional example for rendering third-party avatars to include visual indicators of trust. The avatars include an avatar 804 associated with a user and two avatars 806, 808 associated with respective third parties. In the example of FIG. 8, a visual indicator of trust level is provided by modifying the perimeter of the third-party avatars 806, 808. In this example, the perimeters of the avatars 806, 808 is bolded or made larger. This may indicate a higher level of trust between the respective third parties and the user.

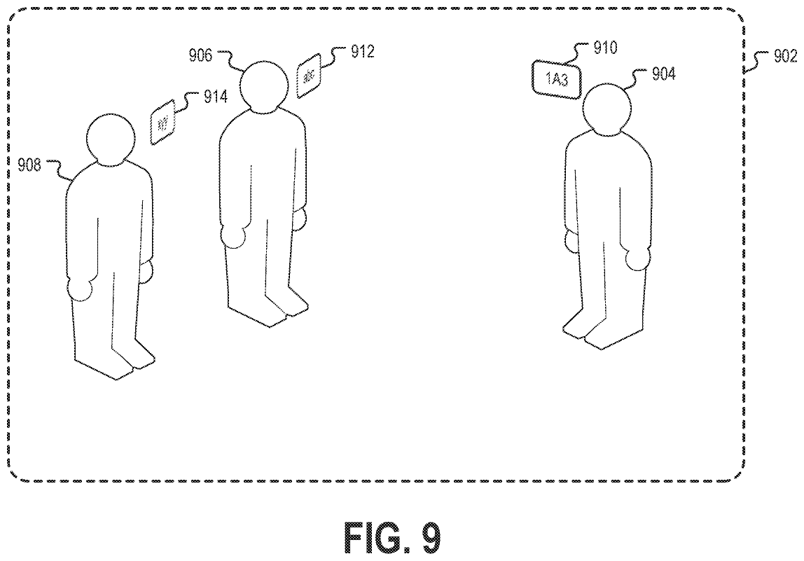

FIG. 9 shows an example VR user interface 902 illustrated with three avatars 904, 906, 908 showing an example way of providing user data to third parties. In this example, the avatar 904 is associated with a user and the avatars 906, 908 are associated with respective third parties. A visual indicator 910 comprises a window, plate, screen, or other suitable visual container for user data. The visual indicator 910 may also include alphanumeric text describing the user data. The avatar 904 may be visible to third parties associated with the third-party avatars 906, 908. The visual indicator 910 may be visible to the third parties, or not visible to the third parties, depending on the trust level between the user and the respective third parties.

FIG. 9 also shows visual indicators 914, 912 associated with the respective third-party avatars 906, 908. Visual indicators 914, 912 may comprise windows, plates, screens, and/or other suitable visual containers to include data about the respective third parties. In some examples, the visual indicators 912, 914 include alphanumeric text indicating a level of trust between the user and the respective third parties. In other examples, a form or shape of the visual indicators includes or represents trust data describing a level of trust between the user and the respective third parties. Also, in some examples, the visual indicators 912, 914 may include various data about the respective third parties that is visible to the user. In some examples, the data displayed at the visual indicators 914, 912 may be selected based on the level of trust between the respective third parties and the user.

In some examples, the rendering of a user avatar may include a visual indicator that is based on the level of trust between the user and one or more third parties. Modifications to the user avatar, in some examples, may be arranged to protect the privacy of the user. In some examples, the visual indicator may be a depiction of a face of the user. For example, if the level of trust between the user and a third party is less than a threshold, then the user's avatar may be rendered without a face or with a face that is not the user's face. If the level of trust between the user and a third party is greater than the threshold, then the user avatar may be rendered with a visual indicator that is the face of the user. The rendered user avatar may be provided to one or more systems associated with the third party

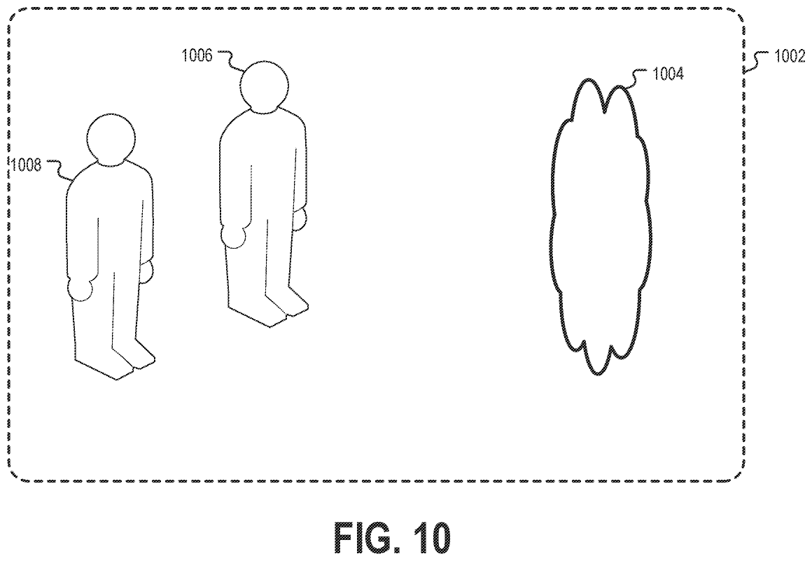

FIG. 10 shows an example VR user interface 1002 illustrated with three avatars 1004, 1006, 1008 demonstrating an additional example for rendering third-party avatars to include visual indicators of trust. In the example of FIG. 10, the avatar 1004 is associated with a user and the avatars 1006, 1008 are associated with one or more third parties. In this example, the avatar 1004 of the user is rendered with a visual indicator based on the level of trust between the user and the one or more third parties. In this example, the level of trust between the user and the one or more third parties may be below a threshold. As a result, the user avatar 1004 is rendered with a visual indicator that obscures the form of the user avatar, in this example making it appear as a cloud.

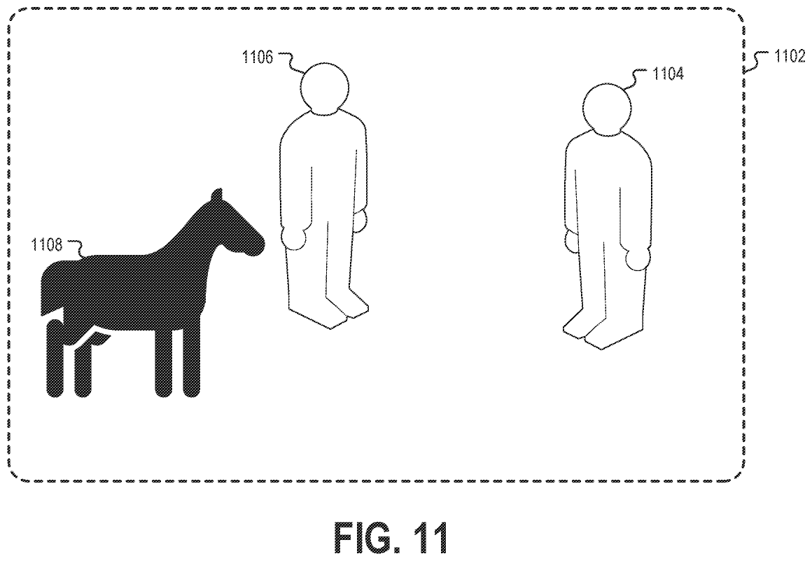

FIG. 11 shows an example VR user interface 1102 illustrated with three avatars 1104, 1106, 1108. In the example of FIG. 11, the avatar 1104 represents a user and the avatars 1106, 1108 represent one or more third parties. In this example, the avatar 1108 has a nonhuman form. It will be appreciated that any of the avatars described herein may have a nonhuman form.

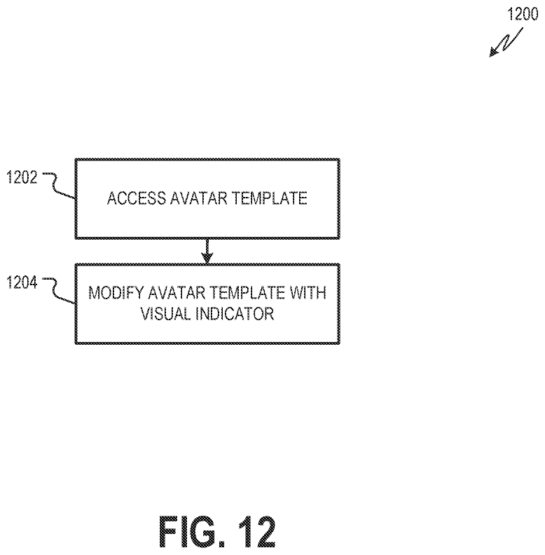

FIG. 12 is a flowchart showing one example of a process flow 1200 that may be executed by the VR host computing system 102 to generate a rendering of an avatar. The process flow 1200 may be executed to generate an avatar associated with a user that may be provided to an appropriate computing device of one or more third parties. In some examples, the process flow 1200 may also be executed to generate an avatar associated with a third party that is provided to an appropriate computing device of a user.

At operation 1202, the VR host computing system 102 may access an avatar template. The avatar template may be data describing a base form of an avatar for a user or a third party. At operation 1204, the VR host computing system 102 may modify the avatar template with a visual indicator. As described herein, this may include modifying the perimeter of the avatar, adding an item on or near the avatar, changing a color of the avatar, and/or the like. The result may be a rendering of the avatar that may be served to a user computing device 130, 132, 134; VR appliance 158, 160, 162; or one or more of systems 104, 106, 108, 110, 112, 114, 118, 120, 122, 124, 126, 128.

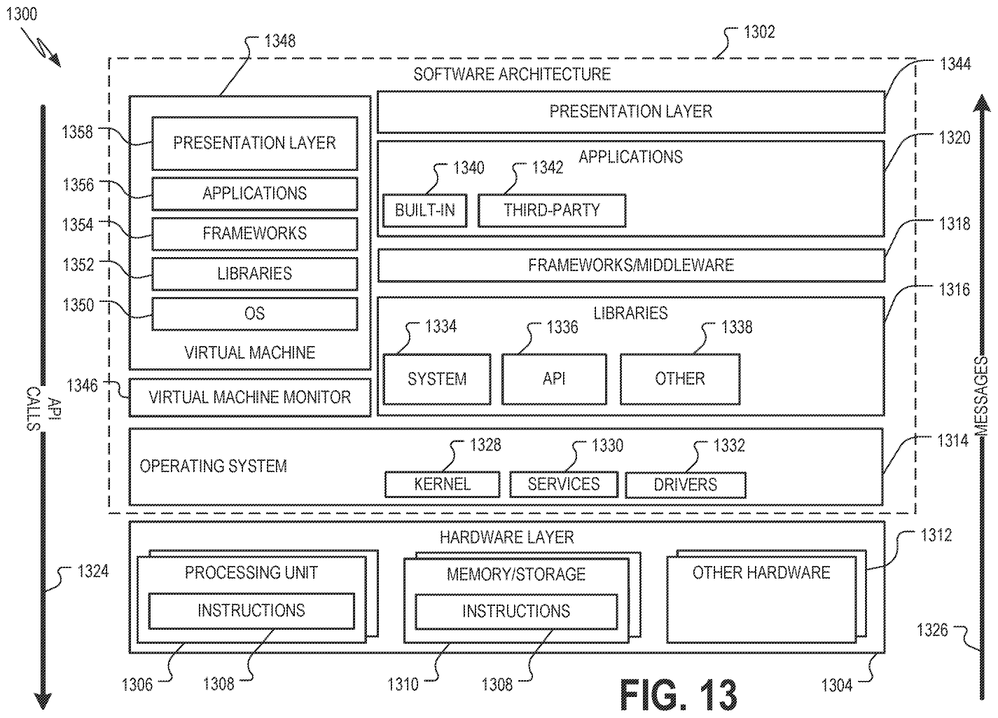

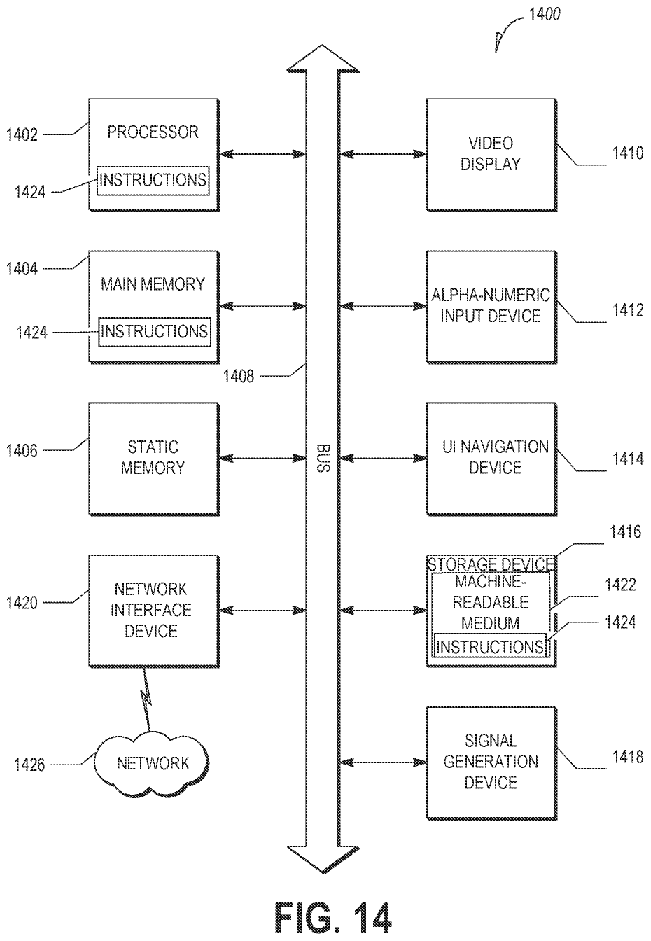

FIG. 13 is a block diagram 1300 showing one example of a software architecture 1302 for a computing device. The software architecture 1302 may be used in conjunction with various hardware architectures, for example, as described herein. FIG. 13 is merely a non-limiting example of a software architecture 1302, and many other architectures may be implemented to facilitate the functionality described herein. A representative hardware layer 1304 is illustrated and can represent, for example, any of the above-referenced computing devices. In some examples, the hardware layer 1304 may be implemented according to an architecture 1400 of FIG. 14.

The representative hardware layer 1304 comprises one or more processing units 1306 having associated executable instructions 1308. The executable instructions 1308 represent the executable instructions of the software architecture 1302, including implementation of the methods, modules, components, and so forth of FIGS. 1-10. The hardware layer 1304 also includes memory and/or storage modules 1310, which also have the executable instructions 1308. The hardware layer 1304 may also comprise other hardware 1312, which represents any other hardware of the hardware layer 1304, such as the other hardware illustrated as part of the architecture 1400.

In the example architecture of FIG. 13, the software architecture 1302 may be conceptualized as a stack of layers where each layer provides particular functionality. For example, the software architecture 1302 may include layers such as an operating system 1314, libraries 1316, middleware layer 1318, applications 1320, and a presentation layer 1344. Operationally, the applications 1320 and/or other components within the layers may invoke application programming interface (API) calls 1324 through the software stack and receive a response, returned values, and so forth illustrated as messages 1326 in response to the API calls 1324. The layers illustrated are representative in nature and not all software architectures have all layers. For example, some mobile or special-purpose operating systems may not provide a middleware layer 1318, while others may provide such a layer. Other software architectures may include additional or different layers.

The operating system 1314 may manage hardware resources and provide common services. The operating system 1314 may include, for example, a kernel 1328, services 1330, and drivers 1332. The kernel 1328 may act as an abstraction layer between the hardware and the other software layers. For example, the kernel 1328 may be responsible for memory management, processor management (e.g., scheduling), component management, networking, security settings, and so on. The services 1330 may provide other common services for the other software layers. In some examples, the services 1330 include an interrupt service. The interrupt service may detect the receipt of a hardware or software interrupt and, in response, cause the software architecture 1302 to pause its current processing and execute an ISR when an interrupt is received. The ISR may generate an alert.

The drivers 1332 may be responsible for controlling or interfacing with the underlying hardware. For instance, the drivers 1332 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1316 may provide a common infrastructure that may be utilized by the applications 1320 and/or other components and/or layers. The libraries 1316 typically provide functionality that allows other software modules to perform tasks in an easier fashion than by interfacing directly with the underlying operating system 1314 functionality (e.g., kernel 1328, services 1330, and/or drivers 1332). The libraries 1316 may include system libraries 1334 (e.g., C standard library) that may provide functions such as memory allocation functions, string manipulation functions, mathematic functions, and the like. In addition, the libraries 1316 may include API libraries 1336 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1316 may also include a wide variety of other libraries 1338 to provide many other APIs to the applications 1320 and other software components/modules.

The middleware layer 1318 (also sometimes referred to as frameworks) may provide a higher-level common infrastructure that may be utilized by the applications 1320 and/or other software components/modules. For example, the middleware layer 1318 may provide various graphical UI functions, high-level resource management, high-level location services, and so forth. The middleware layer 1318 may provide a broad spectrum of other APIs that may be utilized by the applications 1320 and/or other software components/modules, some of which may be specific to a particular operating system or platform.

The applications 1320 include built-in applications 1340 and/or third-party applications 1342. Examples of representative built-in applications 1340 may include, but are not limited to, a contacts application, a browser application, a book reader application, a location application, a media application, a messaging application, and/or a game application. The third-party applications 1342 may include any of the built-in applications 1340 as well as a broad assortment of other applications. In a specific example, the third-party application 1342 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 1342 may invoke the API calls 1324 provided by the mobile operating system such as the operating system 1314 to facilitate functionality described herein.

The applications 1320 may utilize built-in operating system functions (e.g., kernel 1328, services 1330, and/or drivers 1332), libraries (e.g., system libraries 1334, API libraries 1336, and other libraries 1338), or middleware layer 1318 to create UIs to interact with users of the system. Alternatively, or additionally, in some systems, interactions with a user may occur through a presentation layer, such as the presentation layer 1344. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 13, this is illustrated by a virtual machine 1348. A virtual machine creates a software environment where applications/modules can execute as if they were executing on a hardware computing device. The virtual machine 1348 is hosted by a host operating system (e.g., the operating system 1314) and typically, although not always, has a virtual machine monitor 1346, which manages the operation of the virtual machine 1348 as well as the interface with the host operating system (e.g., the operating system 1314). A software architecture executes within the virtual machine 1348, such as an operating system 1350, libraries 1352, frameworks/middleware 1354, applications 1356, and/or a presentation layer 1358. These layers of software architecture executing within the virtual machine 1348 can be the same as corresponding layers previously described or may be different.

FIG. 14 is a block diagram illustrating a computing device hardware architecture 1400, within which a set or sequence of instructions can be executed to cause a machine to perform examples of any one of the methodologies discussed herein. The architecture 1400 may describe, for example, any of the computing devices and/or control circuits described herein. The architecture 1400 may execute the software architecture 1302 described with respect to FIG. 13. The architecture 1400 may operate as a standalone device or may be connected (e.g., networked) to other machines. In a networked deployment, the architecture 1400 may operate in the capacity of either a server or a client machine in server-client network environments, or it may act as a peer machine in peer-to-peer (or distributed) network environments. The architecture 1400 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 1400 includes a processor unit 1402 comprising at least one processor (e.g., a central processing unit (CPU), a graphics processing unit (GPU), or both, processor cores, compute nodes, etc.). The architecture 1400 may further comprise a main memory 1404 and a static memory 1406, which communicate with each other via a link 1408 (e.g., a bus). The architecture 1400 can further include a video display unit 1410, an alphanumeric input device 1412 (e.g., a keyboard), and a UI navigation device 1414 (e.g., a mouse). In some examples, the video display unit 1410, alphanumeric input device 1412, and UI navigation device 1414 are incorporated into a touchscreen display. The architecture 1400 may additionally include a storage device 1416 (e.g., a drive unit), a signal generation device 1418 (e.g., a speaker), a network interface device 1420, and one or more sensors (not shown), such as a GPS sensor, compass, accelerometer, or other sensor.

In some examples, the processor unit 1402 or another suitable hardware component may support a hardware interrupt. In response to a hardware interrupt, the processor unit 1402 may pause its processing and execute an ISR, for example, as described herein.

The storage device 1416 includes a non-transitory machine-readable medium 1422 on which is stored one or more sets of data structures and instructions 1424 (e.g., software) embodying or utilized by any one or more of the methodologies or functions described herein. The instructions 1424 can also reside, completely or at least partially, within the main memory 1404, within the static memory 1406, and/or within the processor unit 1402 during execution thereof by the architecture 1400, with the main memory 1404, the static memory 1406, and the processor unit 1402 also constituting machine-readable media. The instructions 1424 stored at the machine-readable medium 1422 may include, for example, instructions for implementing the software architecture 1302, instructions for executing any of the features described herein, etc.

While the machine-readable medium 1422 is illustrated in an example to be a single medium, the term “machine-readable medium” can include a single medium or multiple media (e.g., a centralized or distributed database, and/or associated caches and servers) that store the one or more instructions 1424. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM) and electrically erasable programmable read-only memory (EEPROM)) and flash memory devices; magnetic disks such as internal hard disks and removable disks; magneto-optical disks; and CD-ROM and DVD-ROM disks.

The instructions 1424 can further be transmitted or received over a communications network 1426 using a transmission medium via the network interface device 1420 utilizing any one of a number of well-known transfer protocols (e.g., hypertext transfer protocol (HTTP)). Examples of communication networks include a LAN, a WAN, the Internet, mobile telephone networks, plain old telephone service (POTS) networks, and wireless data networks (e.g., Wi-Fi, 7G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 77 C.F.R. § 1.72 (b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. A virtual reality host computing system comprising:
at least one hardware processor programmed to perform operations comprising:
receiving, from a user device, an indication that a user avatar for a user is to encounter a third-party avatar associated with a third party in a virtual environment;
accessing trust data describing a level of trust between the user and the third party;
determining a first visual indicator based at least in part on the level of trust between the user and the third party;
generating a rendering of the third-party avatar, the rendering of the third-party avatar comprising the first visual indicator;
serving the rendering of the third-party avatar to the user device for display by the user device to the user;
determining a portion of user data associated with the user that is shareable with the third party, the portion of the user data being determined based at least in part on the trust data; and
sending the portion of the user data to a third-party computing device associated with the third party.

2. The virtual reality host computing system of claim 1, the operations further comprising:
determining a second visual indicator based at least in part on the level of trust between the user and the third party;
generating a rendering of the user avatar, the rendering comprising the second visual indicator; and
serving the rendering of the user avatar to the third-party computing device.

3. The virtual reality host computing system of claim 2, the second visual indicator being a depiction of a face of the user.

4. The virtual reality host computing system of claim 1, the first visual indicator comprising a depiction of an item, and the generating of the rendering of the third-party avatar comprising positioning the depiction of the item at least one of on, over, or beside the third-party avatar.

5. The virtual reality host computing system of claim 1, the first visual indicator comprising a modification to a perimeter of the third-party avatar, and the generating of the rendering of the third-party avatar comprising:
accessing a third-party avatar template; and
modifying a perimeter of the third-party avatar template.

6. The virtual reality host computing system of claim 5, the modifying of the perimeter of the third-party avatar comprising at least one of blurring at least a portion of the perimeter of the third-party avatar or modifying a color of at least a portion of the perimeter of the third-party avatar.

7. The virtual reality host computing system of claim 1, the first visual indicator comprising a color, and the generating of the rendering of the third-party avatar comprising:
accessing a third-party avatar template; and
modifying the third-party avatar template to include the color.

8. The virtual reality host computing system of claim 1, the operations further comprising generating a rendering of a user data interface element, the user data interface element depicting the portion of the user data, the sending of the portion of the user data to the third-party computing device comprising sending the rendering of the user data interface element to the third-party computing device for display in proximity to the user avatar.

9. The virtual reality host computing system of claim 1, the operations further comprising, before sending the portion of the user data to the third-party computing device, receiving, from the user device, a request to provide the portion of the user data to the third party.

10. The virtual reality host computing system of claim 1, the portion of the user data comprising payment element data describing a payment element used for a purchase by the user from the third party.

11. A method of serving a virtual reality user interface to a user, the method comprising:
receiving, by a virtual reality host computing system and from a user device, an indication that a user avatar for the user is to encounter a third-party avatar associated with a third party in a virtual environment;
accessing, by the virtual reality host computing system, trust data describing a level of trust between the user and the third party;
determining, by the virtual reality host computing system, a first visual indicator based at least in part on the level of trust between the user and the third party;
generating, by the virtual reality host computing system, a rendering of the third-party avatar, the rendering of the third-party avatar comprising the first visual indicator;
serving, by the virtual reality host computing system, the rendering of the third-party avatar to the user device for display by the user device to the user;
determining, by the virtual reality host computing system, a portion of user data associated with the user that is shareable with the third party, the portion of the user data being determined based at least in part on the trust data; and
sending, by the virtual reality host computing system, the portion of the user data to a third-party computing device associated with the third party.

12. The method of claim 11, further comprising:
determining, by the virtual reality host computing system, a second visual indicator based at least in part on the level of trust between the user and the third party;
generating, by the virtual reality host computing system, a rendering of the user avatar, the rendering comprising the second visual indicator; and
serving, by the virtual reality host computing system, the rendering of the user avatar to the third-party computing device.

13. The method of claim 12, the second visual indicator being a depiction of a face of the user.

14. The method of claim 11, the first visual indicator comprising a depiction of an item, and the generating of the rendering of the third-party avatar comprising positioning the depiction of the item at least one of on, over, or beside the third-party avatar.

15. The method of claim 11, the first visual indicator comprising a modification to a perimeter of the third-party avatar, and the generating of the rendering of the third-party avatar comprising:
accessing a third-party avatar template; and
modifying a perimeter of the third-party avatar template.

16. The method of claim 15, the modifying of the perimeter of the third-party avatar comprising at least one of blurring at least a portion of the perimeter of the third-party avatar or modifying a color of at least a portion of the perimeter of the third-party avatar.

17. The method of claim 11, the first visual indicator comprising a color, and the generating of the rendering of the third-party avatar comprising:
accessing a third-party avatar template; and
modifying the third-party avatar template to include the color.

18. The method of claim 11, further comprising generating a rendering of a user data interface element, the user data interface element depicting the portion of the user data, the sending of the portion of the user data to the third-party computing device comprising sending the rendering of the user data interface element to the third-party computing device for display in proximity to the user avatar.

19. The method of claim 11, further comprising, before sending the portion of the user data to the third-party computing device, receiving, from the user device, a request to provide the portion of the user data to the third party.

20. A non-transitory machine-readable medium comprising instructions thereon that, when executed by at least one processor, cause the at least one processor to perform operations comprising:
receiving, from a user device, an indication that a user avatar for a user is to encounter a third-party avatar associated with a third party in a virtual environment;
accessing trust data describing a level of trust between the user and the third party;
determining a first visual indicator based at least in part on the level of trust between the user and the third party;
generating a rendering of the third-party avatar, the rendering of the third-party avatar comprising the first visual indicator;
serving the rendering of the third-party avatar to the user device for display by the user device to the user;
determining a portion of user data associated with the user that is shareable with the third party, the portion of the user data being determined based at least in part on the trust data; and
sending the portion of the user data to a third-party computing device associated with the third party.
